(19) United States
(12) Patent Application Publication
(10) Pub. No.: US 2016/0380242 A1
(43) Pub. Date: Dec. 29, 2016

(54) SECONDARY BATTERY

(71) Applicant: SAMSUNG SDI CO., LTD., Yongin-si (KR)

(72) Inventor: Jaesoon JANG, Yongin-si (KR)

(21) Appl. No.: 14/879,552

(22) Filed: Oct. 9, 2015

(30) Foreign Application Priority Data
Jun. 26, 2015 (KR) 10-2015-0091433

(51) Int. Cl. H01M 2/02

(52) U.S. Cl. CPC H01M 2/026; H01M 2/0262; H01M 2002/0297

(57) ABSTRACT

A secondary battery includes an electrode assembly and a case accommodating the electrode assembly. The case includes an inner surface that includes irregularities thereon and an outer surface that is planar.

### CROSS-REFERENCE TO RELATED APPLICATION

Korean Patent Application No. 10-2015-0091433, filed on Jun. 26, 2015, in the Korean Intellectual Property Office, and entitled: “Secondary Battery,” is incorporated by reference herein in its entirety.

### BACKGROUND

1. Field

Embodiments relate to a secondary battery.

2. Description of the Related Art

In general, unlike a primary battery that is not rechargeable, a secondary battery can be repeatedly charged and discharged. Low capacity batteries that use single battery cells are used as power sources for various portable small-sized electronic devices such as cellular phones, and camcorders. High power batteries that use tens of battery cells connected to each other in a battery pack are used as power sources for hybrid vehicles or electric vehicles. The secondary battery includes an electrode assembly, a case accommodating the electrode assembly, and a cap assembly sealing the case.

### SUMMARY

Embodiments are directed to a secondary battery including an electrode assembly and a case accommodating the electrode assembly. The case includes an inner surface that includes irregularities thereon and an outer surface that is planar.

The case may include a bottom surface, a pair of long side surfaces extending from the bottom surface and having a relatively large area, and a pair of short side surfaces extending from the bottom surface and having a relatively small area. The irregularities may be on inner surfaces of the pair of long side surfaces.

The irregularities may have a wavelike configuration and may include concave portions that recede concavely toward the outer surface of the case and convex portions that extend convexly toward the electrode assembly accommodated in the case.

The irregularities may offset an internal pressure applied to a meeting point of the concave portion positioned at one side of the convex portion and the convex portion, and an internal pressure applied to a meeting point of the concave portion positioned at an other side of the convex portion and the convex portion.

The irregularities may have a zigzag configuration and may include recessing portions recessing toward the outer surface of the case and protruding portions protruding toward the electrode assembly accommodated in the case.

The irregularities may offset an internal pressure applied to a meeting point of the recessing portion positioned at one side of the protruding portion and the protruding portion, and an internal pressure applied to a meeting point of the recessing portion positioned at an other side of each of the protruding portion and the protruding portion.

The case may be made of a plastic material.

Embodiments are also directed to a secondary battery including a plurality of electrode assemblies and a case that includes a plurality of accommodating portions that accommodate the plurality of electrode assemblies and barriers positioned between each of the accommodating portions. Both surfaces of each of the barriers may include irregularities. The outer surface of the case may be planar.

The irregularities may have a wavelike configuration and may include concave portions that extend concavely away from an adjacent one of the electrode assemblies positioned at one side of each of the harriers and convex portions that extend convexly toward the adjacent one of the electrode assemblies positioned at the side of each of the barriers.

The irregularities may have a zigzag configuration and may include recessing portions recessed away from an adjacent one of the electrode assemblies positioned at one side of each of the barriers and protruding portions protruding toward the adjacent one of the electrode assemblies positioned at the side of each of the barriers.

The case may be made of a plastic material.

### BRIEF DESCRIPTION OF THE DRAWINGS

Features will become apparent to those of skill in the art by describing in detail exemplary embodiments with reference to the attached drawings in which:

FIG. 1 illustrates an exploded perspective view of a secondary battery according to an embodiment;

FIGS. 2A and 2B illustrate plan views depicting a case having irregularities in the secondary battery illustrated in FIG. 1;

FIGS. 3A and 3B illustrate plan views depicting a case having irregularities in a secondary battery according to another embodiment;

FIG. 4 illustrates a plan view depicting a case according to another embodiment; and

FIG. 5 illustrates a plan view depicting a case according to still another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

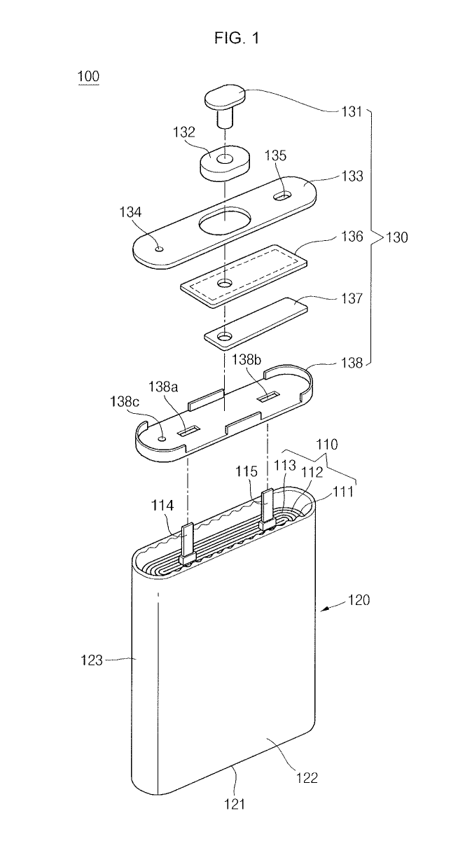

FIG. 1 illustrates a perspective view of a secondary battery according to an embodiment.

Referring to FIG. 1, the secondary battery 100 according to an embodiment includes an electrode assembly 110, a case 120, and a cap assembly 130.

The electrode assembly 110 includes a first electrode plate 111, a second electrode plate 112 and a separator 113 interposed between the first electrode plate 111 and the second electrode plate 112. The electrode assembly 110 may be formed by winding or laminating a stacked structure including the first electrode plate 111, the separator 113 and the second electrode plate 112. The first electrode plate 111 may function as a positive electrode and the second electrode plate 112 may function as a negative electrode.

The first electrode plate 111 may be formed by coating a first electrode active material made of, for example, a transition metal oxide, on a first electrode collector formed of a metal foil made of aluminum (Al). A first electrode tab 114 may be attached to the first electrode plate 111. One end of the first electrode tab 114 may be electrically connected to the first electrode plate 111 and the other end of the first electrode tab 114 may protrude to an upper portion of the electrode assembly 110.

The second electrode plate 112 may be formed by coating a second electrode active material made of, for example, graphite or carbon, on a second electrode collector formed of a metal foil made of copper (Cu) or nickel (Ni). A second electrode tab 115 may be attached to the second electrode plate 112. One end of the second electrode tab 115 may be electrically connected to the second electrode plate 112 and the other end of the second electrode tab 115 may protrude to an upper portion of the electrode assembly 110.

The separator 113, positioned between the first electrode plate 111 and the second electrode plate 112, may inhibit short circuits between the first electrode plate 111 and the second electrode plate 112 and may allow for movement of lithium ions. The separator 113 may be made of polyethylene (PE), polypropylene (PP) or a composite material of polyethylene (PE) and polypropylene (PP), as examples.

The electrode assembly 110 may be accommodated in the case 120 with an electrolyte. The electrolyte may include a mixture of a lithium salt LiPF₆ or LiBF₄ and an organic solvent, such as EC, PC, DEC, EMC or DMC. The electrolyte may be in a liquid, solid, or gel phase.

The case 120 may have a substantially hexagonal shape having an opening through which the electrode assembly 110 is inserted and placed. The case 120 may have a bottom surface 121, a pair of long side surfaces 122 upwardly extending from the bottom surface 121 and having a relatively large area, and a pair of short side surfaces 123 upwardly extending from the bottom surface 121 and having a relatively small area.

The pair of short side surfaces 123 may be curved so as to correspond to the winding shape of the electrode assembly 110. The case 120 is made of a plastic material. For example, the case 120 may be made of a material selected from propylene carbonate (PC), polypropylene (PP), polyethylene (PE) and polyethylene terephthalate (PET). When the case 120 is made of a plastic material, the manufacturing cost and weight of the secondary battery may be reduced. However, the case 120 made of a plastic material may undergo excessive distortion due to swelling. Accordingly, in order to minimize the distortion of the case 120 due to swelling, the internal shape of the case 120 may be changed to provide a configuration of the case 120 capable of dispersing the pressure applied to the case 120 and increasing rigidity of the case 120. The configuration of the case 120 will be described in detail below.

The cap assembly 130 may be positioned on the electrode assembly 110 and coupled to the opening of the case 120 to seal the case 120. The cap assembly 130 may include an electrode terminal 131, a gasket 132, a cap plate 133, an insulation plate 136, a terminal plate 137 and an insulation case 138. The gasket 132 may be inserted into a region between the electrode terminal 131 and the cap plate 133. The electrode terminal 131 and the terminal plate 137 may be electrically connected. The insulation plate 136 may insulate the cap plate 133 and the terminal plate 137 from each other. An electrolyte injection hole 134 may be formed at one side of the cap plate 133. In order to close the electrolyte injection hole 134 after an electrolyte is injected into the electrolyte injection hole 134, a plug may be installed. In addition, a safety vent 135 may be formed at the other side of the cap plate 133. The safety vent 135 may be formed to be thinner than the cap plate 133. When the internal pressure of the case 120 is greater than or equal to an operating pressure of the safety vent 135, the safety vent 135 may release internal gases. The insulation case 138 may be formed in the opening of the case 120 to seal the case 120. The insulation case 138 may be made of a polymer resin having an insulating property, such as polypropylene (PP). Holes 138a and 138b may be formed in the insulation case 138 to allow the first electrode tab 114 and the second electrode tab 115 to pass therethrough. In addition, an electrolyte passing hole 138c may be formed at a location of the insulation case 138 corresponding to the electrolyte injection hole 134.

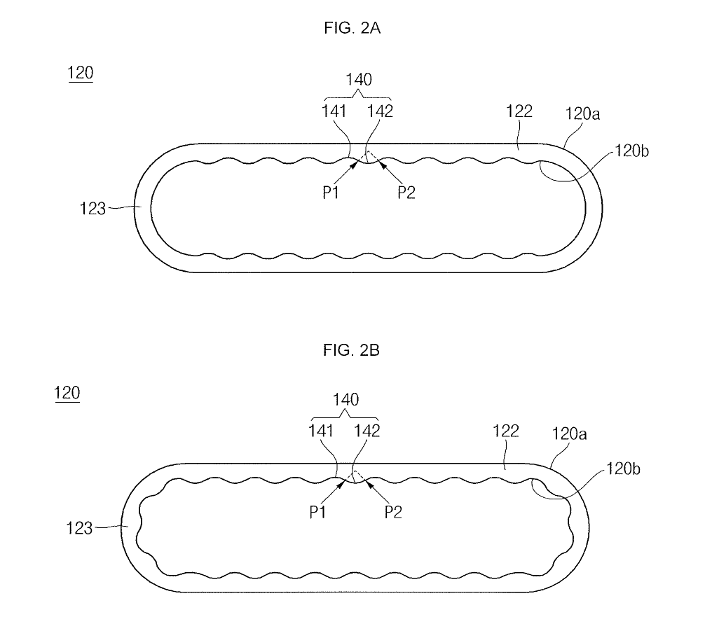

FIGS. 2A and 2B illustrate plan views depicting a case having irregularities in the secondary battery illustrated in FIG. 1.

Referring to FIG. 2A, in order to minimize the distortion of the case 120 due to swelling, wavelike (e.g., having a corrugated shape or structure) irregularities 140 may be formed on an inner surface 120b of the case 120. In general, swelling may occur towards the relatively wide long side surface 122 of the case 120 in the secondary battery 100. For example, if the swelling occurs to the secondary battery 100, such swelling may occur at the long side surface 122 of the case 120.

According to embodiments, irregularities 140 may be formed on the long side surface 122 of the case 120, thereby suppressing swelling. The irregularities 140 may be formed on the inner surface 120b of the case 120, while an outer surface 120a of the case 120 may be maintained to be planar. Herein, the description that the outer surface 120a of the case 120 is “planar” indicates that the outer surface 120 of the long side surfaces 122 are relatively flat or smooth and do not include the irregularities 140 described with respect to the inner surface 120b of the case 120.

The irregularities 140 may be formed in a wavelike configuration and include concave portions 141 formed concavely toward the outer surface 120a of the case 120 and convex portions 142 formed convexly toward the electrode assembly 110 accommodated in the case 120. The concave portions 141 and the convex portions 142 may be alternately formed on inner surface 120b of the long side surfaces 122. The concave portions 141 and the convex portions 142 may disperse the internal pressure applied to the case 120. For example, the irregularities 140 may reduce the internal pressure applied to the case 120 per unit area by increasing an area of the inner surface 120b.

Further, the irregularities 140 may be configured to offset internal pressures generated inside the case 120. The internal pressures generated inside the case 120 may be applied to be perpendicular to the inner surface 120b of the case 120. Therefore, neighboring ones of the internal pressures radially applied to the irregularities 140 formed on the inner surface 120b of the case 120 may be offset. For example, as illustrated in FIG. 2A, an internal pressure P1 applied to a meeting point of the concave portion 141 positioned at the left side of the convex portion 142 and the convex portion 142, and an internal pressure P2 applied to a meeting point of the concave portion 141 positioned at the right side of of the convex portion 142 and the convex portion 142, may be offset. The internal pressures P1 and P2 applied from opposite sides of the concave portion 142 may be in opposite directions, thereby offsetting each other. Therefore, the irregularities 140 may reduce the internal pressures applied to the case 120, thereby minimizing distortion of the case 120 when the case 120 swells. The more the concave portions 141 and the convex portions 142 are formed, the better the irregularities 140 disperse the internal pressures applied to the case 120 and the more the internal pressures are offset.

In addition, as illustrated in FIG. 2B, the irregularities 140 may also be formed on the short side surfaces 123 of the case 120. If the irregularities 140 are formed on both of the long side surfaces 122 and the short side surfaces 123 on the inner surface 120b of the case 120, an area of the inner surface 120b of the case 120 may be increased, compared to a case where the irregularities 140 are formed only on the long side surfaces 122, thereby more efficiently dispersing the internal pressures applied to the case 120.

As described above, in the secondary battery 100 according to an embodiment, the irregularities 140 may be formed on the inner surface 120b of the case 120 made of a plastic material to disperse the internal pressures applied to the case 120 and to offset the internal pressures applied to the case 120 each other, thereby minimizing distortion of the case 120.

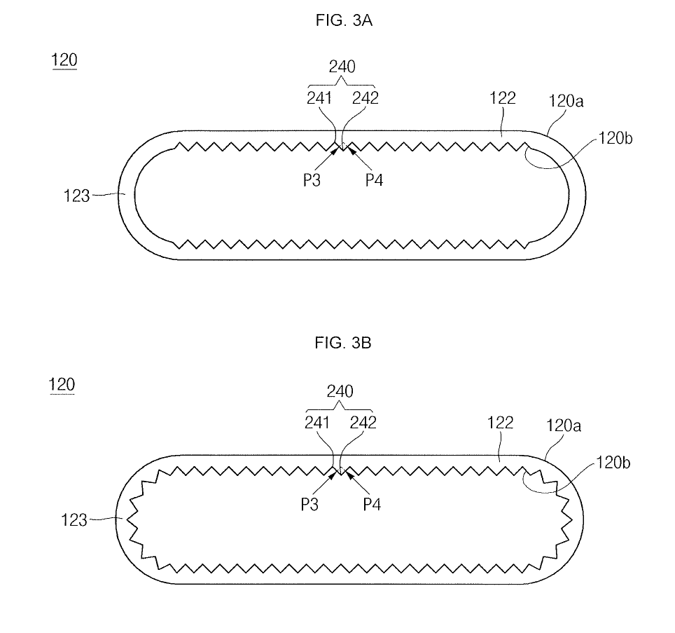

FIGS. 3A and 3B illustrate plan views depicting a case having irregularities in a secondary battery according to another embodiment.

Referring to FIG. 3A, the irregularities 240 may be formed on the inner surface 120b of the case 120. The irregularities may be formed on the long side surfaces 122 of the case 120, thereby suppressing swelling. The irregularities 240 may be formed only on the inner surface 120b of the case 120, while the outer surface 120a of the case 120 may be maintained with a planar shape. The irregularities 240 may be formed in a zigzag configuration (e.g., having a saw tooth shape or configuration) and may include recessing portions 241 recessing toward the outer surface 120a of the case 120 and protruding portions 242 protruding toward the electrode assembly 110 accommodated in the case 120. The recessing portions 241 may recess as sharp-angled triangles and the protruding portions 242 may protrude as a sharp-angled triangles. In addition, the recessing portions 241 and the protruding portions 242 may be alternately formed on the long side surfaces 122. The recessing portions 241 and the protruding portions 242 may serve to disperse the internal pressures applied to the case 120. The irregularities 240 may reduce the internal pressures applied to the case 120 per unit area by increasing the area of the inner surface 120b of the case 120.

The irregularities 240 may be configured to offset internal pressures generated inside the case 120. As illustrated in FIG. 3A, an internal pressure P3 applied to a meeting point of the recessing portion 241 that is positioned at the left side of the protruding portion 242 and the protruding portion 242, and an internal pressure P4 applied to a meeting point of the recessing portion 241 that is positioned at the right side of the protruding portion 242 and the protruding portion 242, are offset. For example, the internal pressures P3 and P4 applied from opposite sides of the protruding portion 242 are in opposite directions, thereby offsetting each other. Therefore, the irregularities 240 may reduce the internal pressures applied to the case 120, thereby minimizing distortion of the case 120 when the case 120 swells.

In addition, as illustrated in FIG. 3B, the irregularities 240 may also be formed on the short side surfaces 123 of the case 120. If the irregularities 240 are formed on both the long side surfaces 122 and the short side surfaces 123 on the inner surface 120b of the case 120. Accordingly, an area of the inner surface 120b of the case 120 may be increased, compared to a case where the irregularities 140 are formed only on the long side surfaces 122, thereby more efficiently dispersing the internal pressures applied to the case 120.

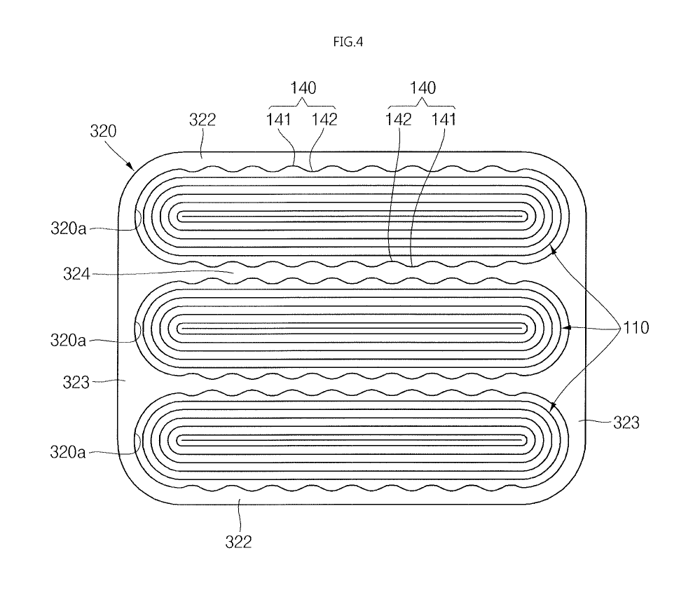

FIG. 4 illustrates a plan view depicting a case according to another embodiment.

Referring to FIG. 4, the case 320 according to another embodiment may be made of a plastic material and may include a plurality of accommodating portions 320a into which a plurality of electrode assemblies 110 are inserted. In addition, barriers 324 may be formed in each of the plurality of accommodating portions 320a. For example, the plurality of electrode assemblies 110 may be separated from each other by the barriers 324 between the accommodating portions 320a of the case 320. In addition, the case 320 may include a pair of long side surfaces 322 having a relatively large area and a pair of short side surfaces 323 connecting the pair of long side surfaces 322 and having a relatively small area. The barriers 324 may be formed to be perpendicular to the long side surfaces 322.

Irregularities 140 may be formed on the barriers 324, thereby minimizing distortion of the case 320 due to swelling. The irregularities 140 may be formed in a wavelike configuration and may include concave portions 141 formed concavely away the electrode assemblies 110 positioned at respective sides of each of the barriers 324 and convex portions 142 formed convexly toward the electrode assemblies 110 positioned at the respective sides of each of the barriers 324. In addition, the irregularities 140 may also be formed on inner surfaces of the pair of long side surfaces 322. Here, the irregularities 140 formed on the inner surfaces of the pair of long side surfaces 322 include concave portions 141 formed concavely toward the outside of the case 320 and convex portions 142 formed convexly toward the electrode assembly 110 inserted into the inside of the case 320. Since the irregularities 140 may be the same as the irregularities 140 illustrated in FIG. 2A, a detailed description thereof will not be repeated.

The irregularities 140 may be configured to disperse internal pressures applied to the case 320 and to offset internal pressures generated inside the case 320, thereby minimizing distortion of the case 320.

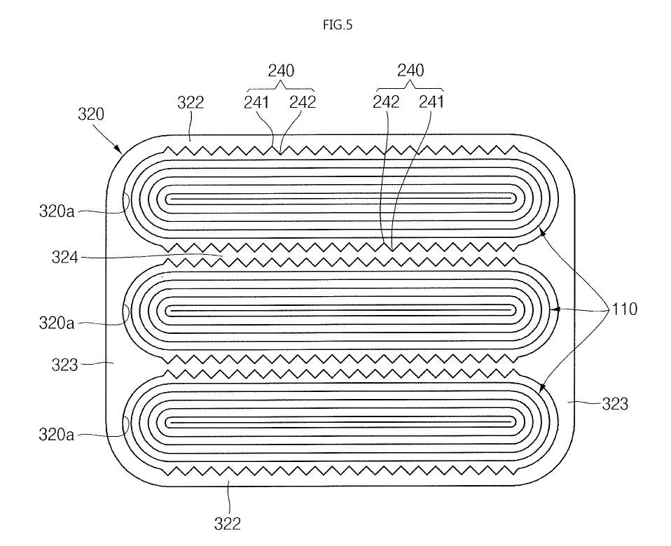

FIG. 5 illustrates a plan view depicting the case according to still another embodiment.

The case illustrated in FIG. 5 is substantially the same as the case illustrated in FIG. 4, except for shapes of the irregularities.

Referring to FIG. 5, the case 320 according to another embodiment may be made of a plastic material and may include a plurality of accommodating portions 320a into which a plurality of electrode assemblies 110 are inserted. In addition, barriers 324 may be formed in each of the plurality of accommodating portions 320a. The case 320 may include a pair of long side surfaces 322 having a relatively large area and a pair of short side surfaces 323 connecting the pair of long side surfaces 322 and having a relatively small area. The barriers 324 may be formed to be parallel with the long side surfaces 322.

Irregularities 240 may be formed on the barriers 324, thereby minimizing distortion of the case 320 due to swelling. The irregularities 240 may be formed on both surfaces of the barriers 324. The irregularities 240 may be formed in a zigzag configuration and may include recessing portions 241 recessed away from the electrode assembly 110 positioned at an adjacent side of each of the barriers 324 and protruding portions 242 protruding toward the electrode assembly 110 positioned at the adjacent side of each of the barriers 324. The recessing portions 241 may be recessed and the protruding portions 242 may protrude in a form of a sharp-angled triangle. In addition, the irregularities 240 may also be formed on inner surfaces of the pair of long side surfaces 322. Here, the irregularities 240 formed on the inner surfaces of the pair of long side surfaces 322 include recessing portions 241 recessed toward the outside of the case 320 and protruding portions 242 protruding toward the electrode assembly 110 inserted into the inside of the case 320. Since the irregularities 240 may be the same as the irregularities 240 illustrated in FIG. 3A, a detailed description thereof will not be repeated.

The irregularities 240 may be configured to disperse internal pressures applied to the case 320 and to offset internal pressures generated inside the case 320, thereby minimizing distortion of the case 320.

By way of summation and review, for the cost and weight reasons of secondary batteries, a metal used as a material of the case is being replaced by a plastic material. However, the case made of a plastic material may be excessively distorted due to swelling.

Embodiments provide a secondary battery that can minimize distortion of a case made of a plastic material by forming irregularities on the case. The secondary battery according to an embodiment may minimize distortion of the case by dispersing an internal pressure applied to the case and offsetting the internal pressures applied to the irregularities.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A secondary battery, comprising:
an electrode assembly; and
a case accommodating the electrode assembly,
wherein the case includes an inner surface that includes irregularities thereon and an outer surface that is planar.

2. The secondary battery as claimed in claim 1, wherein:
the case includes a bottom surface, a pair of long side surfaces extending from the bottom surface and having a relatively large area, and a pair of short side surfaces extending from the bottom surface and having a relatively small area, and
the irregularities are on inner surfaces of the pair of long side surfaces.

3. The secondary battery as claimed in claim 1, wherein the irregularities have a wavelike configuration and include concave portions that recede concavely toward the outer surface of the case and convex portions that extend convexly toward the electrode assembly accommodated in the case.

4. The secondary battery as claimed in claim 3, wherein the irregularities offset an internal pressure applied to a meeting point of a concave portion that is positioned at one side of the convex portion and the convex portion, and an internal pressure applied to a meeting point of a concave portion that is positioned at an other side of the convex portion and the convex portion.

5. The secondary battery as claimed in claim 1, wherein the irregularities have a zigzag configuration and include recessing portions recessing toward the outer surface of the case and protruding portions protruding toward the electrode assembly accommodated in the case.

6. The secondary battery as claimed in claim 5, wherein the irregularities offset an internal pressure applied to a meeting point of a recessing portion that is positioned at one side of the protruding portion and the protruding portion, and an internal pressure applied to a meeting point of a recessing portion that is positioned at an other side of each of the protruding portion and the protruding portion.

7. The secondary battery as claimed in claim 1, wherein the case is made of a plastic material.

8. A secondary battery, comprising:
a plurality of electrode assemblies; and
a case including a plurality of accommodating portions that accommodate the plurality of electrode assemblies and barriers positioned between each of the accommodating portions,
wherein both surfaces of each of the barriers include irregularities, and
the outer surface of the case is planar.

9. The secondary battery as claimed in claim 8, wherein the irregularities have a wavelike configuration and include concave portions that extend concavely away from an adjacent one of the electrode assemblies positioned at one side of each of the barriers and convex portions that extend convexly toward the adjacent one of the electrode assemblies positioned at the side of each of the barriers.

10. The secondary battery as claimed in claim 8, wherein the irregularities have a zigzag configuration and include recessing portions recessed away from an adjacent one of the electrode assemblies positioned at one side of each of the barriers and protruding portions protruding toward the adjacent one of the electrode assemblies positioned at the side of each of the barriers.

11. The secondary battery as claimed in claim 8, wherein the case is made of a plastic material.
